(19) United States
(12) Patent Application Publication
(10) Pub. No.: US 2026/0160306 A1
(43) Pub. Date: Jun. 11, 2026

(54) Adjuster for a Friction Brake

(71) Applicant: KNORR-BREMSE Systeme fuer Nutzfahrzeuge GmbH, Muenchen (DE)

(72) Inventors: Michael BLESSING, Muenchen (DE); Ralf WEBER, Muenchen (DE)

(21) Appl. No.: 18/707,328

(22) PCT Filed: Nov. 11, 2022
(86) PCT No.: PCT/EP2022/081684

§ 371 Date: May 3, 2024

(30) Foreign Application Priority Data
Nov. 16, 2021 (DE) 10 2021 129 824.5

(51) Int. Cl. F16D 65/18; F16D 65/56; F16D 125/64

(52) U.S. Cl. CPC F16D 65/18; F16D 65/567; F16D 2125/64

(57) ABSTRACT

An adjusting device for a friction brake having at least one brake pad includes a carrier and a length setting element displaceable along a main axis, which has a first setting element and a second setting element, wherein the setting elements form a transmission in such a way that a rotation of the setting elements relative to one another causes a change in a length of the length setting element along a main axis, wherein one of the setting elements has a circumferentially arranged feed element.

### BACKGROUND AND SUMMARY

The invention relates to an adjustment device for a friction brake comprising at least one brake lining, having a support, a longitudinal adjustment device which is displaceable along a main axis relative to the housing and has a first adjustment element and a second adjustment element, the adjustment elements form a gear mechanism in such a way that a rotation of the adjustment elements relative to one another brings about a change in a length of the longitudinal adjustment device along a main axis.

Adjustment devices of the above-mentioned type are known in the prior art. Friction brakes comprise brake linings, which wear out over time. As a result, the longitudinal adjustment device, which is part of the mechanism by means of which the brake pads are pressed onto the brake in the direction of the main axis, has to travel along a longer path to achieve a braking effect. This is because, in the case of worn-out brake pads, what is known as an air gap forms, which, when braking, has to first be bridged until the brake pads are in contact with the brake again.

In order to reduce the air gap, a length of the longitudinal adjustment device can be changed. In particular, the length of the longitudinal adjustment device can be increased to compensate for the air gap.

So that this change in length of the longitudinal adjustment device firstly takes place when the air gap is too big, and secondly does not revert back, for example as a result of vibration-induced movement of the adjustment devices, locking devices or fixing devices, in particular which are pneumatically detachable, are known.

These locking devices or fixing devices often require a specific construction or arrangement in or on the disc brake and need to be supplied for example with compressed air. Furthermore, a change in the length of the longitudinal adjustment is often possible only in a specific operating mode of the disc brake.

In view of the above, the invention addresses the problem of developing an adjustment device of the type mentioned at the outset in such a way that it can be used universally, and the change in length can be carried out efficiently.

The problem is solved by an adjustment device according to the independent claims. The dependent claims relate to advantageous embodiments.

The problem is solved by an adjustment device for a friction brake comprising at least one brake pad, having a support, a longitudinal adjustment device which is displaceable along a main axis relative to the housing and has a first adjustment element and a second adjustment element, the adjustment elements forming a gear mechanism in such a way that a rotation of the adjustment elements relative to one another brings about a change in an extent of the longitudinal adjustment device along a main axis, wherein one of the adjustment elements has a feed device which is circumferentially arranged in the circumferential direction.

Devices arranged outside the adjustment device can adjust and/or fix the length of the longitudinal adjustment device by means of engagement in the feed device which are accessible from the outside, wherein devices required for controlling the adjustment device can be arranged outside the adjustment device and can be configured as desired. As a result, there is no longer any dependency on one type of energy supply (pneumatic, electric, etc.), and the longitudinal adjustment device, which is moved together with the brake during each braking process, is simplified.

In further embodiments, the adjustment device comprises an actuator for displacing the longitudinal adjustment device along the main axis relative to the support, the actuator being rotatably attached to an articulated portion on the support, the actuator having an actuating portion which is at a distance from the articulated portion, and the actuator being connected, for force transmission, to the longitudinal adjustment device in a connecting portion which is at a distance from the articulated portion and the actuating portion.

The movement of the longitudinal adjustment device relative to the support, by means of which the braking force is applied to the brake pad, is brought about by the actuator, which functions as a type of lever, in such a way that a torque applied to the actuating portion can generate a large braking force. As a result, an adaptation of the braking force relative to the force applied to the actuating portion can be achieved.

In further embodiments, the articulated portion is arranged between the connecting portion and the actuating portion.

As a result, in particular a reversal of the direction of a force applied in the actuating portion can be achieved.

In further embodiments, the connecting portion is arranged between the articulated portion and the actuating portion.

It is thus simple to bring about an adjustment of the lever action.

In further embodiments, the adjustment device comprises a feed triggering device which, when actuated, is arranged so as to bring about a rotation of the adjustment device relative to one another by means of an engagement portion engaging in the feed device.

Thus, whenever an adjustment process is to be attempted, the feed triggering device can be actuated, which can directly bring about a longitudinal adjustment.

In further embodiments, the actuator is arranged to actuate the feed triggering device during the displacement of the longitudinal adjustment device.

The actuator can displace the longitudinal adjustment device over a predetermined normal displacement path along the main axis. If the longitudinal adjustment device can be displaced over a normal displacement path which is greater than the predetermined normal displacement path, then there is an air gap. In order to compensate for this air gap, the actuator actuates the feed device through the feed triggering device so as to increase the length of the longitudinal adjustment device along the main axis and thus reduce the air gap. The air gap is thus compensated for in a particularly efficient manner.

In further embodiments, the feed triggering device comprises a path receiving device for receiving an actuating path of the feed triggering device for the case in which the feed triggering device is blocked in the region of the engagement portion.

If the engagement portion is blocked, for example because the brake pad is in contact with the brake disc, and therefore the adjustment elements are blocked, then the force that is exerted on the feed triggering device is introduced into the path receiving device, which device is compressed thereby. The path forced on the feed triggering device by the actuation is thus received by the path receiving device. If this were not the case, then if the material were overloaded, damage could occur to both the feed triggering device and the feed device.

In further embodiments, the feed device has a ramp face and a blocking face, the ramp face being inclined with respect to the main axis in each case, and the blocking face being arranged substantially parallel to the main axis, the feed triggering device having at least one drive face which is inclined with respect to the main axis, and a blocking face which is arranged substantially parallel to the main axis, the drive face being arranged for support on the ramp faces in such a way that, in the event of contact between the drive face and the ramp face, a movement of the feed triggering device along the main axis toward the feed device brings about a torque on the feed device, the housing having a feed holding device which has at least one blocking face arranged substantially parallel to the main axis and a drive face which is inclined with respect to the main axis.

The actuator brings about a displacement of the feed triggering device along the main axis when the air gap is greater than permitted, and thus the displacement path of the longitudinal adjustment device is greater than the predetermined normal displacement path. In this case, the actuator can be actuated further than when the air gap is the intended size. By moving the feed triggering device, the drive face of the feed triggering device comes into contact with at least one of the ramp faces of the feed device. Arranging the faces so as to be inclined, oblique or diagonal relative to the main axis, and moving the faces toward one another along the main axis results in a force in the circumferential direction of the feed device. The feed device and the adjustment elements connected thereto are thus rotated, and the length of the longitudinal adjustment device is thus increased. An enlarged air gap is thus responded to and compensated for in a particularly flexible and simple manner.

The blocking faces delimit the end of the adjustment increment so that the adjustment that is possible within a braking process is delimited in an efficient manner.

In further embodiments, the feed device comprises a majority of ramp faces and blocking faces which are arranged so as to be distributed over a circumference of the feed device.

The adjustment can thus take place over a larger adjustment region.

In further embodiments, the one or more ramp faces and blocking faces of the feed device are arranged in each case so as to alternate along the circumference.

Whenever the feed device has been rotated to such an extent that a ramp face following the feed device in the circumferential direction can be reached by the drive face, another adjustment process can thus be initiated so that it is possible to adjust the fixing in a precise manner.

In further embodiments, the blocking faces of the feed triggering device and the feed holding device are arranged in such a way that the distance between the two blocking faces along the circumference is m-times the extent of the drive face of the feed device in the circumferential direction and additionally is 0.1 to 0.9 times the above-mentioned extent, m being a whole number which is greater than or equal to zero.

As a result, the feed triggering device and the feed holding device each engage alternately in the drive faces and blocking faces during a feed of the feed device. The fixing of the feed device is thus improved.

In further embodiments, the adjustment device comprises a first snap-in element having a snap-in ramp, and a second snap-in element having a snap-in ramp, the first snap-in element and the second snap-in element being arranged so as to be rotated with respect to one another by 0.1 to 0.9 times the extent, and the feed device having at least one radially protruding snap-in projection for engaging at least temporarily in the snap-in ramps, the snap-in elements being arranged at a distance from one another in the axial direction so that the snap-in projection is arranged in the axial direction between the snap-in element.

During a movement of the longitudinal adjustment device in the axial direction, the snap-in projection engages alternately in the first snap-in element and, after actuating the brake, in the second snap-in element. If the movement of the longitudinal adjustment device in the axial direction is greater than the normal displacement path, then by placing the snap-in projection on the snap-in ramps, a feed of the feed device is brought about. This brings about reliable and efficient feeding, and thus a reliable and efficient change in the length of the longitudinal adjustment device when the air gap is too big.

In further embodiments, the first snap-in element and/or the second snap-in element each comprise a plurality of snap-in ramps arranged in a circumferential direction.

The adjustment can thus take place over a larger adjustment region.

In further embodiments, the snap-in projection engages in the first snap-in element and/or is in contact therewith when the friction brake is in a relaxed state.

The feed device is thus efficiently prevented from turning back.

In further embodiments, the snap-in projection engages in the second snap-in element and/or is in contact therewith when the friction brake is actuated.

When the snap-in projection has contact and is axially displaced further beyond the contact, then the feed device is actuated by means of the contact of the snap-in ramps.

In further embodiments, the first snap-in element and/or the second snap-in element are supported on the support by means of a path-receiving device.

This means that the snap-in element and/or the snap-in projection are protected against damage that can result from the feed device being blocked, for example when the brake pad is in contact with the brake disc and thus blocks the rotation of the adjustment elements.

In further embodiments, the feed device comprises a freewheel and a spindle portion, the feed triggering device having an engagement portion for engaging in the spindle portion of the feed device in such a way that an axial displacement of the feed triggering device during braking brings about a rotation of the feed device via the freewheel clutch and, during an axial displacement of the feed triggering device when the brake is relaxed, brings about a movement of the freewheel clutch relative to the feed device.

A stepless adjustment of the length of the longitudinal adjustment device is thus possible.

The invention will be described in the following with reference to exemplary embodiments which do not limit, but rather merely schematically illustrate, the invention.

### BRIEF DESCRIPTION OF THE DRAWINGS

FIG. 1 is a schematic section through an adjustment device according to one embodiment of the invention;

FIG. 2 is a schematic section through an adjustment device according to one embodiment of the invention, comprising an actuator;

FIG. 3 is a schematic detail of the embodiment shown in FIG. 2, comprising a feed device, a feed triggering device and a feed holding device;

FIG. 4 is a schematic detail as in FIG. 3 during a first phase of a braking process;

FIG. 5 is a schematic detail as in FIG. 3 during a second phase of a braking process;

FIG. 6 is a schematic detail as in FIG. 3 during a third phase of a braking process;

FIG. 7 is a schematic detail as in FIG. 3 during a fourth phase of a braking process;

FIG. 8 is a schematic detail as in FIG. 3 during a fifth phase of a braking process;

FIG. 9 is a schematic section through an adjustment device according to one embodiment of the invention, comprising a first snap-in element and a second snap-in element;

FIG. 10 is a schematic detail of the embodiment shown in FIG. 9, comprising the first snap-in element, the second snap-in element and a snap-in projection;

FIG. 11 is a schematic detail as in FIG. 10 during a first phase of a braking process;

FIG. 12 is a schematic detail as in FIG. 10 during a second phase of a braking process;

FIG. 13 is a schematic detail as in FIG. 10 during a third phase of a braking process;

FIG. 14 is a schematic detail as in FIG. 10 during a fourth phase of a braking process;

FIG. 15 is a schematic section through an adjustment device according to one embodiment of the invention, comprising a freewheel;

FIG. 16 is a schematic view of an unwound spindle portion of the freewheel according to the embodiment from FIG. 15, and

FIG. 17 is a schematic detail of an engagement portion engaging in the spindle portion according to the embodiment from FIG. 15.

### DETAILED DESCRIPTION OF THE DRAWINGS

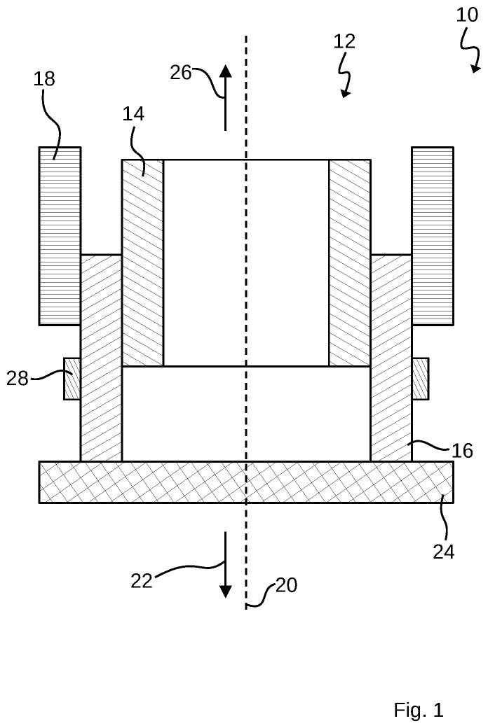

The adjustment device 10 shown in FIG. 1 comprises a longitudinal adjustment device 12, which has a first adjustment element 14 and a second adjustment element in the form of an adjustment pot 16. The first adjustment element 14 is designed so as to be substantially hollow cylindrical and has an outer thread which engages in an inner thread of the adjustment pot 16 which is likewise designed so as to be substantially hollow cylindrical.

The first adjustment element 14 is arranged so as to be rotationally fixed with respect to a support, which in this case is in the form of a housing 18, but so as to be displaceable along a main axis 20. The adjustment pot 16 is arranged so as to be rotatable about the main axis 20 and displaceable along said axis.

During a braking process, that is to say for example when actuating the brake, the first adjustment element 14 and the adjustment pot 16 are displaced along the main axis 20 in a braking direction 22 in order to press a brake pad 24 against a brake disc (not shown) so that a braking effect is achieved. After the braking process, the first adjustment device 14 under adjustment pot 16 are displaced in a relaxing direction 26 along the main axis 20 counter to the braking direction 22. As a result, the brake pad 24 is lifted off the brake disc, and a gap is produced between the brake pad 24 and the brake disc, which is known as the air gap.

A displacement path is the path that the first adjustment device 14 and the adjustment path 16 travel along the main axis 20 during the braking process. If the air gap is set correctly according to predefined characteristics of the brake, then the displacement path corresponds to a normal displacement path. If, on the other hand, the brake disc and/or the brake pad 24 is worn, and the air gap is bigger, then the displacement path is greater than the normal displacement path.

On an outer surface thereof, the adjustment pot 16 has a feed device 28 which is circumferentially arranged in the circumferential direction. By rotating the feed device 28, a length of the longitudinal displacement device 12 along the main axis 20 can be set, since the first adjustment device 14 and the adjustment pot 16 are connected by means of the threads thereof and form for example a screw channel.

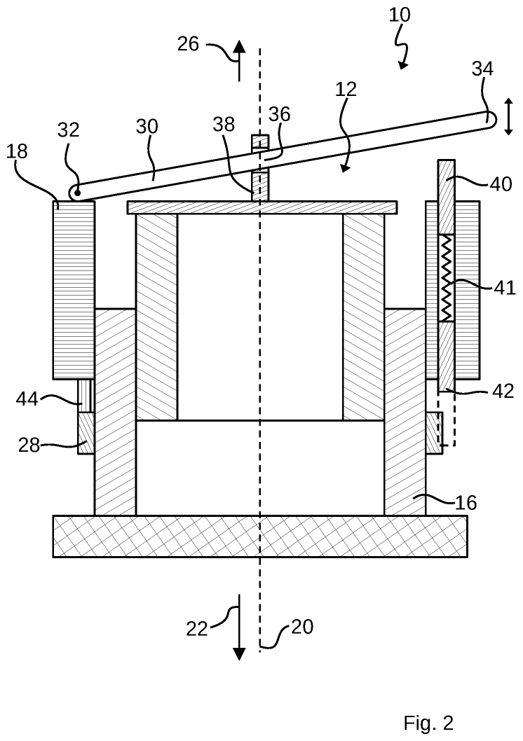

In order to actuate the brake, that is to say in order to displace the longitudinal adjustment device 12 along the main axis 20, in the embodiment shown in FIG. 2, an actuator is provided in the form of a lever 30. An articulated portion, for example as arranged here as an articulated end 32 on an end of the lever 30, is rotatably mounted on the housing 18.

Moreover, the lever 30 has an actuating portion, in this case arranged for example on an end of the lever 30 as an actuation end 34, at which actuation end a braking force can be introduced. Between the articulated end 32 and the actuation end 34, the lever 30 has a connecting portion 36 on which the lever is connected to a force receiving device 38. The force receiving device 38 is connected in turn to the longitudinal adjustment device 12 so that forces introduced at the actuation end 34 are introduced via the force receiving device 38 into the longitudinal adjustment device 12. In this process, the forces can act both in the braking direction 22 and in the relaxing direction 26.

A feed triggering device 40 which is displaceable parallel to the main axis 20 is arranged in the region of the actuation end 34. The feed triggering device 40 has an engagement portion 42 which is designed to engage in the feed device 28 and thereby rotate the adjustment pot 16.

The feed device 28 is arranged on the adjustment pot 16 so as to be rotationally fixed, but so as to be displaceable in the axial direction.

The feed triggering device 40 is also displaced in the braking direction 22 so that the engagement portion 42 engages in the feed device 28 and, if the displacement path is greater than the normal displacement path, that is to say that for example the air gap between the brake pad 24 and the brake disc is too big, the adjustment pot 16 is rotated, which increases the length of the longitudinal adjustment device 12. As a result, the displacement path is smaller again during the next braking process. This is repeated during each braking process until the displacement path is no longer greater than the normal displacement path, that is to say that the air gap has returned to normal.

The housing 18 has a feed holding device 44 which is arranged for engagement in the feed device 28. In further embodiments, the feed holding device 44 can also be arranged so as to prevent the adjustment pot 16 from turning back.

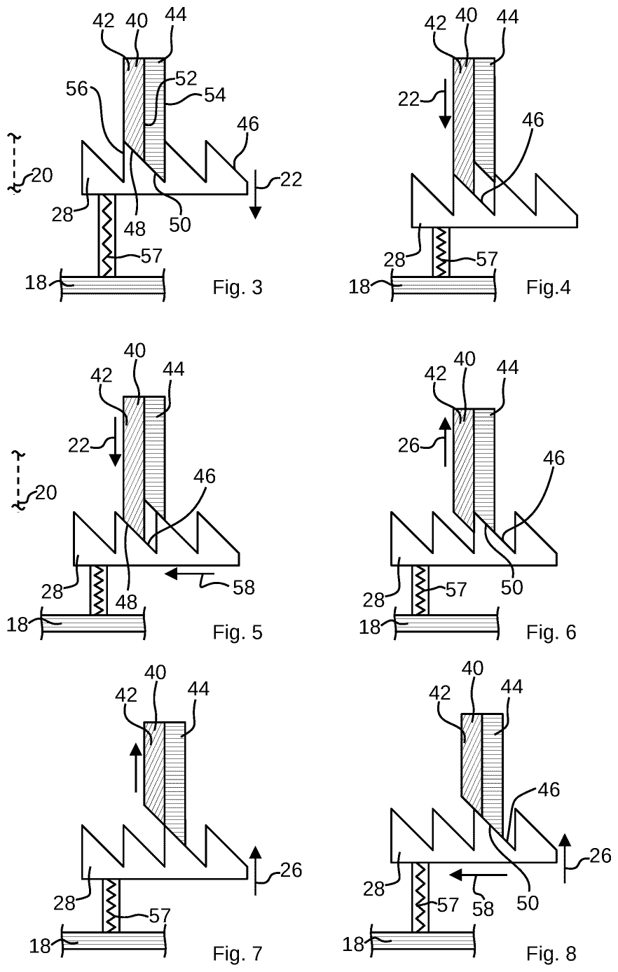

As shown for example in FIG. 3, the feed holding device 44 can also be arranged directly next to the engagement portion 42. In this case, the feed device 28 is shown schematically as a cut-out, unwound from the circumference. The axially movable feed device 28 is supported on the housing 18 in the axial direction by means of a path receiving device in the form of a spring 57.

The feed device 28 has for example ramp faces 46 which are arranged so as to be inclined with respect to the main axis 20. For support on the ramp faces 46, the engagement portion 42 and the feed holding device 44 also have inclined ramp faces, for example in the form of drive faces 48, 50. Both the engagement portion 42 and the feed holding device 44 further comprise blocking faces 52, 54 to be mounted on blocking faces 56 of the feed device 28.

In a first phase of a braking process, the longitudinal adjustment device 12 is displaced in the braking direction 22 by means of the lever 30. If the displacement path is not greater than the normal displacement path, then all the parts of the longitudinal adjustment device 12 and the feed triggering device 40 return to the position shown in FIG. 3 after the braking process.

In a second phase of the braking process, which is shown in FIG. 4, the engagement portion 42 of the feed triggering device 40 is displaced further in the braking direction 22. The engagement portion 42 and in particular the drive face 48 remains in contact with the feed device 28, and in turn in particular with the ramp face 46, and presses these in the braking direction 22 against the spring 57, which thus begins to exert an opposing force.

If the air gap of the brake is already overcome in this phase, then the brake pad 24 is in contact with the brake disc and cannot be rotated any more, and therefore the adjustment pot 16 cannot be rotated any more either. In this case, the engagement portion 42 further presses the feed device 28 against the spring 57, which receives part of the adjustment path of the feed triggering device 40, but the feed device 28 does not rotate. The spring 41 also receives part of the adjustment path of the feed triggering device 40 so that the components are not destroyed by excessive pressure. After the relaxing of the brake, all the components return to their original position, as shown in FIG. 3. In the following, it is assumed that the air gap is too big, and therefore the adjustment pot 16 can be rotated.

In further embodiments, for example only one of the springs 41, 57 is provided, and therefore the entire excess adjustment path is received by a spring 41, 57.

In a third phase of the braking process, which is shown in FIG. 5, the drive face 48 is in contact with one of the ramp faces 46. Since the two faces 46, 48 are inclined with respect to the displacement direction of the engagement portion 42, a transverse force is produced in the circumferential direction 58. As a result, the feed device 28 is rotated, and the length of the longitudinal adjustment device 12 along the main axis 20 is increased.

In a fourth phase of the braking process, which is shown in FIG. 6, the engagement portion 42 is displaced in the relaxing direction 26. The feed holding device 44, which has been temporarily changed over to the next ramp face 46 by moving the feed device 28 in the braking direction 22, rests with the drive face 50 thereof on the ramp face 46 and likewise exerts a transverse force thereon as a result of the force exerted by the spring device 57. However, since the engagement portion 42 still blocks a rotation of the feed device 28, no further rotation takes place.

In a fifth phase of the braking process, which is shown in FIG. 7, the engagement portion 42 of the feed triggering device 40 is displaced further in the relaxing direction 26 until it no longer blocks the rotation of the feed device 28.

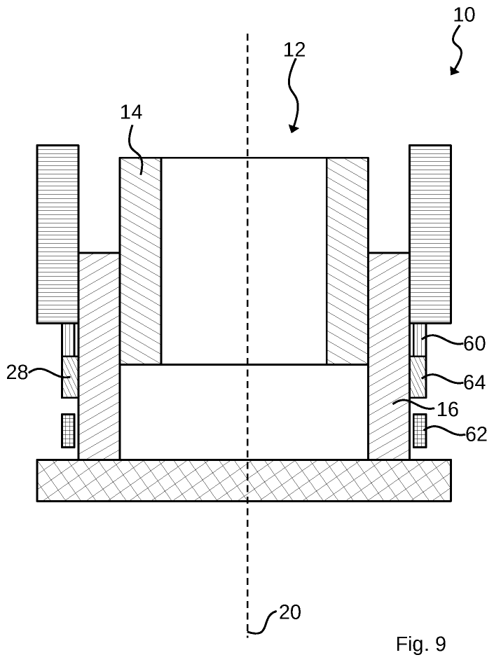

As shown in FIG. 8, the feed device 28 subsequently moves further in the relaxing direction 26 and is rotated further in the circumferential direction 58 by the ramp face 50 of the feed holding device 44. By means of the additional movement of the feed device 28 in the relaxing direction 26, as a result of the inclination of the faces 46, 50 with respect to the relaxing direction 26 and the resulting transverse force, a rotation of the feed device 28 in the circumferential direction 58 is brought about. The length of the longitudinal adjustment device 12 in the direction of the main axis 20 is thus increased in turn, and the air gap is thus reduced.

As soon as the air gap is small enough, the displacement path during a braking process once again corresponds to the normal displacement path, and the feed device 28 can no longer rotate during a braking process.

In further embodiments, the rotational movement of the feed device 28 brought about by the mutually adjoining ramp faces 46, 48, 50 can also be caused for example by the fact that the engagement portion 42 moves faster in the braking direction 22 than the feed device 28 as a result of the lever action of the lever 30.

In another embodiment which is shown in FIG. 9, the adjustment device 10 has a first snap-in element 60 which is connected in a stationary manner to the housing 18. Moreover, the adjustment device 10 has a second snap-in element 62. The snap-in element 60, 62 are each designed to be hollow cylindrical and arranged substantially coaxially with the longitudinal adjustment device 12 along the main axis 20. The feed device 28 has one or more snap-in projections 64 which are arranged so as to engage in the snap-in element 60, 62.

The first snap-in element 60 and/or the second snap-in element 62 can be mounted on the housing 18, regardless of the further design thereof, in additional embodiments for example by means of a path-receiving device, for example a spring device.

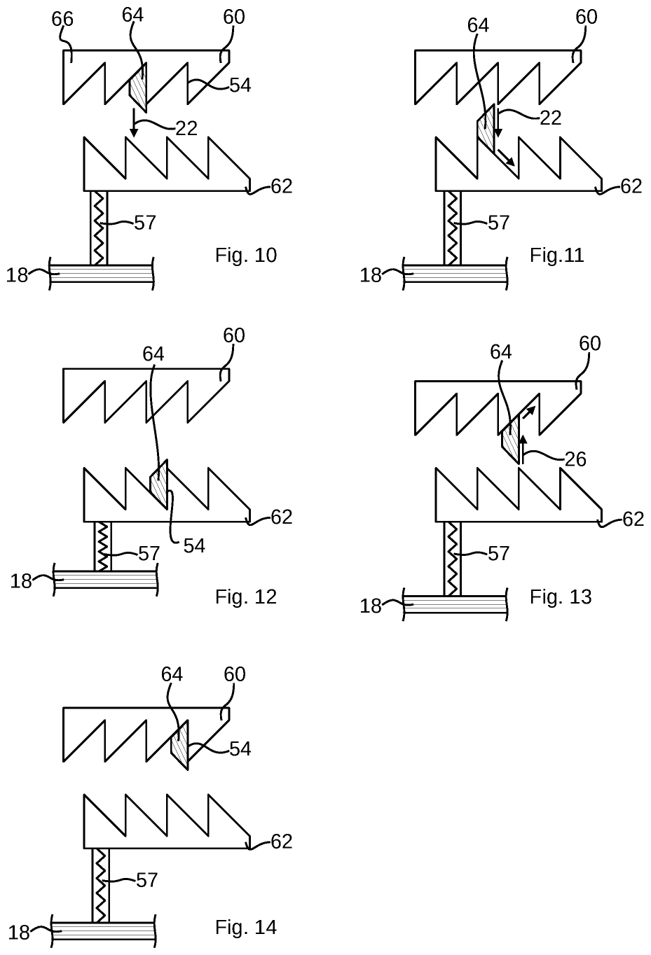

In FIG. 10, the first snap-in element 60 and the second snap-in element 62 are shown unwound. The snap-in element 60, 62 each have a plurality of snap-in ramps 66 which each have a ramp face 46 and a blocking face 54.

The snap-in projection 64 has a trapezoidal footprint, and therefore it has a drive face in each of the braking direction 22 and the relaxing direction 26. The snap-in projection 64 moves together with the longitudinal adjustment device 12 during each braking process.

In a first phase of a braking process, as shown in FIG. 11, the snap-in projection 64 thus moves in the braking direction 22 until it comes into contact with the second snap-in device 62. If the displacement path is greater than the normal displacement path then, as already described above, a movement of the snap-in projection 64 in the circumferential direction device that the feed device 28 and thus the snap-in projection 64 are not prevented from rotating by the brake pad 24. In a second phase of the braking process, this movement can be continued until the snap-in projection 64 is in contact with the blocking face 54, as shown in FIG. 12.

In a third phase of a braking process, as shown in FIG. 13, the snap-in projection 64 moves in the relaxing direction 26 until it comes into contact with the first snap-in device 60 again. By means of the additional movement of the snap-in projection 64 in the relaxing direction 26, the feed device 28 is rotated further in the circumferential direction until the snap-in projection 64 is in contact with the blocking face 54 of the next snap-in ramp 66 of the first snap-in device 60, as shown in FIG. 14. The movement in the circumferential direction is repeated during each braking process as long as the displacement path is greater than the normal displacement path.

In additional embodiments, for example the snap-in element 60, 62 can be part of the feed device 28, the snap-in projection 64 being arranged on the engagement portion 42 of the feed triggering device 40, as shown in some embodiments.

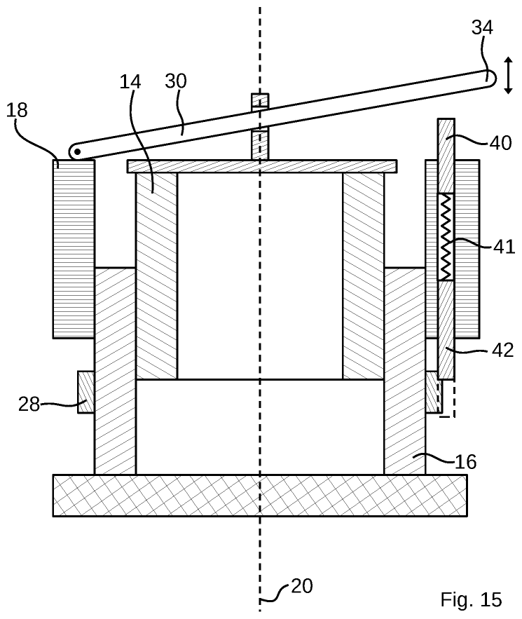

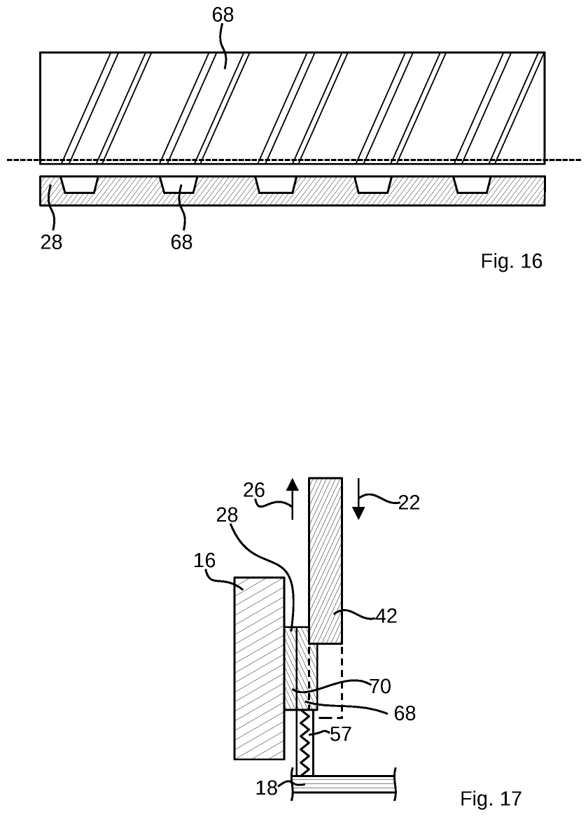

In additional embodiments, one of which is shown by way of example in FIG. 15, the feed device 28, as shown unwound in FIG. 16, has a plurality of diagonally extending grooves 68, in which the engagement portion 42 engages when it is fed in the braking direction 22 by the lever 30.

The grooves 68 are mounted on a freewheel 70 as shown in FIG. 17, which device can transmit a torque in only one direction. When the grooves 68 are driven in the circumferential direction by means of the engagement portion, then the adjustment pot 16 is rotated. If, however, the grooves 68 are driven in the opposite direction during a movement of the engagement portion 42 in the relaxing direction 26, then only the ring to which the grooves 68 are attached rotates together with the freewheel 70, whereas the adjustment pot 16 remains stationary.

In additional embodiments, the articulated portion 32 can be arranged for example between the actuating portion 34 and the connecting portion 36.

In additional embodiments, the feed triggering device 40 can be arranged for example in any desired portion of the lever 30.

In additional embodiments, the feed triggering device 40 can be actuated for example by an additional mechanism which is actuated when the air gap is too big.

In additional embodiments, regardless of the other features, the feed device 28 can be arranged on a surface of one of the adjustment device 14, 16. The surface can be for example an outer surface, for example a surface of which the normals point away from the axis 20, for example a convex surface, or for example an inner surface facing the axis 20 and/or arranged around the axis 20, for example a concave surface. In the case of a for example substantially hollow cylindrical design of the adjustment device 14, 16, for example the outer surface is formed by a lateral surface of the cylinder, and for example the inner surface is formed by a surface of the internal hollow space of the hollow cylinder. Likewise for example a flange, projection, recess or another structure can be provided on the adjustment device 14, 16, on the surface of which the feed device 28 is arranged.

### LIST OF REFERENCE SIGNS

10 adjustment device
12 longitudinal adjustment device
14 first adjustment element
16 adjustment pot (second adjustment element)
18 housing (support)
20 main axis
22 braking direction
24 brake pad
26 relaxing direction
28 feed device
30 lever (actuator)
32 articulated end (articulated portion)
34 actuation end (actuating portion)
36 connecting portion
38 force receiving device
40 feed triggering device
41 spring (path receiving device)
42 engagement portion
44 feed holding device
46 ramp face
48 drive face/ramp face (of the engagement portion of the feed triggering device)
50 drive face/ramp face (of the feed holding device)
52 blocking face (of the engagement portion of the feed triggering device)
54 blocking face (of the feed holding device)
56 blocking face (of the feed device)
57 spring (path receiving device)
58 circumferential direction
60 first snap-in element
62 second snap-in element
64 snap-in projection
66 snap-in ramp
68 groove
70 freewheel

1.-17. (canceled)

18. An adjustment device for a friction brake having at least one brake pad, comprising:
a support; and
a longitudinal adjustment device displaceable along a main axis, the longitudinal adjustment device comprising:
a first adjustment element and a second adjustment element, wherein
the first and second adjustment elements form a gear mechanism such that a rotation of the first and second adjustment elements relative to one another brings about a change in an extent of the longitudinal adjustment device along the main axis, and
one of the first and second adjustment elements has a circumferentially arranged feed device.

19. The adjustment device according to claim 18, further comprising:
an actuator for displacing the longitudinal adjustment device along the main axis relative to the support, wherein
the actuator is rotatably mounted on an articulated portion on the support,
the actuator has an actuating portion which is at a distance from the articulated portion, and
the actuator is connected, for force transmission, to the longitudinal adjustment device in a connecting portion which is at a distance from the articulated portion and the actuating portion.

20. The adjustment device according to claim 19, wherein
the articulated portion is arranged between the connecting portion and the actuating portion.

21. The adjustment device according to claim 19, wherein
the connecting portion is arranged between the articulated portion and the actuating portion.

22. The adjustment device according to claim 18, further comprising:
a feed triggering device which, when actuated, is arranged so as to bring about a rotation of the first and second adjustment elements relative to one another by way of an engagement portion engaging in the feed device.

23. The adjustment device according to claim 19, further comprising:
a feed triggering device which, when actuated, is arranged so as to bring about a rotation of the first and second adjustment elements relative to one another by way of an engagement portion engaging in the feed device.

24. The adjustment device according to claim 23, wherein
the actuator is arranged so as to actuate the feed triggering device during the displacement of the longitudinal adjustment device.

25. The adjustment device according to claim 22, wherein
the feed triggering device comprises a path receiving device for receiving an actuating path of the feed triggering device when the feed triggering device is blocked in a region of the engagement portion.

26. The adjustment device according to claim 22, wherein
the feed device comprises a ramp face and a blocking face, the ramp face being inclined with respect to the main axis, and the blocking face being arranged substantially parallel to the main axis,
the feed triggering device comprises at least one drive face which is inclined with respect to the main axis, and a blocking face, which is arranged substantially parallel to the main axis, wherein
the drive face is arranged for support on the ramp face such that, in an event of contact between the drive face and the ramp face, a movement of the feed triggering device along the main axis toward the feed device brings about a torque on the feed device, and
the support has a feed holding device which has at least one blocking face arranged substantially parallel to the main axis and a drive face which is inclined with respect to the main axis.

27. The adjustment device according to claim 26, wherein
the feed device comprises a plurality of ramp faces and blocking faces which are arranged so as to be distributed over a circumference of the feed device.

28. The adjustment device according to claim 27, wherein
the one or more ramp faces and blocking faces of the feed device are arranged so as to alternate along the circumference.

29. The adjustment device according to claim 26, wherein
the blocking faces of the feed triggering device and the feed holding device are arranged such that the distance between the two blocking faces along the circumference is m-times the extent of the drive face of the feed means in the circumferential direction and additionally is 0.1 to 0.9 times the above-mentioned extent, m being a whole number which is greater than or equal to zero.

30. The adjustment device according to claim 18, further comprising:
a first snap-in element having a snap-in ramp, and
a second snap-in element having a snap-in ramp, wherein
the first snap-in element and the second snap-in element are arranged so as to be rotated with respect to one another in the circumferential direction by 0.1 to 0.9 times the extent of a snap-in ramp, and
the feed device has at least one radially protruding snap-in projection for engaging at least temporarily in the snap-in ramps, the snap-in elements being arranged at a distance from one another in the axial direction so that the snap-in projection is arranged in the axial direction between the snap-in elements.

31. The adjustment device according to claim 30, wherein
the first snap-in element and/or the second snap-in element each have a plurality of snap-in ramps arranged in a circumferential direction.

32. The adjustment device according to claim 30, wherein
the snap-in projection engages in the first snap-in element and/or is in contact therewith when the friction brake is relaxed.

33. The adjustment device according to claim 30, wherein
the snap-in projection engages in the second snap-in element and/or is in contact therewith when the friction brake is actuated.

34. The adjustment device according to claim 30, wherein
the first snap-in element and/or the second snap-in element is supported on the support through a path-receiving device.

35. The adjustment device according to claim 22, wherein
the feed device comprises a freewheel and a spindle portion,
the feed triggering device has an engagement portion for engaging in the spindle portion of the feed device such that an axial displacement of the feed triggering device during braking brings about a rotation of the feed device via the freewheel by way of the engagement portion and, during an axial displacement of the feed triggering device when the brake is relaxed, brings about a rotation of the freewheel clutch by way of the engagement portion relative to the feed device.
